(19) United States
(12) Patent Application Publication
(10) Pub. No.: US 2017/0173857 A1
(43) Pub. Date: Jun. 22, 2017

(54) METHOD AND APPARATUS FOR MANUFACTURING A CUSHION MAT AND CUSHION MAT MANUFACTURED THEREWITH

(71) Applicant: TreeLine Co., Ltd., Seongnam-si (KR)

(72) Inventors: Bong Yong Park, Seongnam-si (KR); Hyun Ki Song, Yongin-si (KR); Seok Ho Lee, Gimpo-si (KR)

(21) Appl. No.: 15/381,898

(22) Filed: Dec. 16, 2016

(30) Foreign Application Priority Data
Dec. 18, 2015 (KR) 10-2015-0181909

(51) Int. Cl. B29C 65/18; B29D 99/00; B29C 33/42; B29C 65/00

(52) U.S. Cl. CPC B29C 65/18; B29C 66/00145; B29D 99/0092; B29C 33/42; B29L 2031/58

(57) ABSTRACT

A method and an apparatus for manufacturing a cushion mat and a cushion mat thus manufactured are disclosed. An apparatus for manufacturing a cushion mat may include: a lower mold that has a cavity formed in its upper surface and is configured to receive a first sheet and a inner filler sequentially, where the first sheet may be disposed such that a boundary of the first sheet is exposed at a periphery part of the cavity; an upper mold that is configured to heat-seal the first sheet and a second sheet onto both sides of the inner filler by mating with the lower mold while the second sheet is disposed between the upper mold and the inner filler; and air suction nozzles that are disposed at the periphery part of the cavity of the lower mold to remove residual air from between the second sheet and the inner filler.

### CROSS-REFERENCE TO RELATED APPLICATIONS

This application claims the benefit of Korean Patent Application No. 10-2015-0181909, filed with the Korean Intellectual Property Office on Dec. 18, 2015, the disclosure of which is incorporated herein by reference in its entirety.

### BACKGROUND

1. Technical Field

The present invention relates to a method and an apparatus for manufacturing a cushion mat and to a cushion mat manufactured with the method and apparatus. More particularly, the invention relates to a method and an apparatus for manufacturing a cushion mat and to a cushion mat thus manufactured, which does not discharge endocrine disruptors or the like.

2. Description of the Related Art

A playroom or a home in which children often run about generally has a mat placed on the floor to protect the children from falls as well as to provide soundproofing. This type of mat may include a cushion material within and an outer skin enveloping the cushion material without.

According to the related art, however, manufacturing a mat involves molding the cushion material and outer skin from PVC and attaching the two elements with adhesive. As large amounts of endocrine disruptors such as dioxins and volatile organic compounds, produced from the adhesive, etc., are discharged through the outer skin, the endocrine disruptors may enter a person's body both via respiration and through skin contact.

Thus, a method of heat-fusing the outer skin onto either side of the cushion material has been proposed. However, during the heat-fusing, the air remaining between the cushion material and the outer skin cannot be discharged, resulting in air pockets remaining between the outer skin and the cushion material in a finished mat product. This in turn may increase the rate of defects in the mat products, lowering the consumer's confidence and possibly degrading a product's appearance. Moreover, if a detached portion is stepped on, the air within may be moved about so that the area of the detached portion may grow even larger, exacerbating the problem above.

### PRIOR ART DISCLOSURE

Korean Patent Laid-Open No. 10-2014-0102916

### SUMMARY OF THE INVENTION

To resolve the problems described above, an aspect of the invention aims to provide a method and apparatus for manufacturing a cushion mat and a cushion mat manufactured using the method and apparatus, where the cushion mat is made to be environmentally friendly in that it does not discharge substances that are toxic to the human body, such as endocrine disruptors, because its several layers are not attached with adhesive. Also, the occurrence of the sheet being detached by air remaining in the filler material can be prevented, so that the quality of the product and the consumers' level of confidence toward the product can be improved. The cushion mat can be readily perceived even during nighttime, thus providing for various usages such as in the context of children playrooms, camp sites, etc. The cushion mat can also allow a wheelchair to readily move over the cushion mat without tangling and as such can be particularly useful in a medical context.

According to one feature of the invention, an apparatus for manufacturing a cushion mat 1 may be provided, which includes an inner filler 2 made of a synthetic resin expanded foam member, and a first sheet 3 and a second sheet 4 that respectively cover an upper surface and a lower surface of the inner filler 2. The apparatus may include: a lower mold 10 that has a cavity 11 formed in its upper surface and is configured to receive the first sheet 3 and the inner filler 2 sequentially, where the first sheet 3 may be disposed such that a boundary of the first sheet 3 is exposed at a periphery part of the cavity 11; an upper mold 20 that is configured to heat-seal the first sheet 3 and the second sheet 4 onto both sides of the inner filler 2 by mating with the lower mold 10 while the second sheet 4 is disposed between the upper mold 20 and the inner filler 2; and air suction nozzles 30 that are disposed at the periphery part of the cavity 11 of the lower mold 10 to remove residual air from between the second sheet 4 and the inner filler 2 by vacuum suction.

According to another feature of the invention, an apparatus for manufacturing a cushion mat may be provided, where a concave part 12, which includes the cavity 11 and the periphery part of the cavity 11 in a recessed form, is formed in the upper side of the lower mold 10; and a protrusion part 21, which is configured to mate with the concave part 12 of the lower mold 10, is formed in the lower side of the upper mold 20. The air suction nozzles 30 can be installed such that the front ends of the air suction nozzles 30 are exposed at an inner wall of the concave part 12 of the lower mold 10.

According to still another feature of the invention, a method of manufacturing a cushion mat 1 may be provided, where the cushion mat 1 includes an inner filler 2 made of a synthetic resin expanded foam member, and a first sheet 3 and a second sheet 4 that respectively cover an upper surface and a lower surface of the inner filler 2. The method may include: disposing the first sheet 3 by inserting the first sheet 3 in a cavity 11 formed in a lower mold 10 such that the boundary is exposed at a periphery part of the cavity 11; inserting the inner filler 2 into the cavity 11 of the lower mold 10 such that the inner filler 2 is stacked over an upper surface of the first sheet 3; disposing the second sheet 4 over an upper surface of the inner filler 2 such that a boundary overlaps the boundary of the first sheet 3; and heat-sealing the first and second sheets 3, 4 onto both sides of the inner filler 2 by way of an upper mold 20 mating with the lower mold 10 while removing residual air from between the inner filler 2 and the second sheet 4 by vacuum suction via an air suction nozzle 30.

According to another feature of the invention, a cushion mat may be provided that is manufactured with an apparatus for manufacturing a cushion mat or a method of manufacturing a cushion mat as described above such that there is no residual air between the first and second sheets 3, 4 and the inner filler 2.

According to an embodiment of the present invention, a cushion mat 1 can be provided in which the first and second sheets 3, 4 are attached by thermal fusion or high-frequency fusion, without using adhesive, each onto either side of the inner filler 2. As there is no discharge of toxic substances, the cushion mat is environmentally friendly and particularly suitable for medical facilities or use by children. Also, when the first and second sheets 3, 4 are attached to both sides of the inner filler 2, any air remaining between the first and second sheets 3, 4 and the inner filler 2 may be discharged, allowing improved heat-sealing efficiency between the first and second sheets 3, 4 and the inner filler 2, and thereby improving the quality of the product and increasing product reliability. Since the first and second sheets 3, 4 thus may not become detached from the inner filler 2, a beautiful appearance can be maintained. Also, the problem of air moving about when a detached portion is stepped on and causing adjacent portions to become detached, so that the area of the detached portion grows ever larger, can be avoided.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a cushion material according to an embodiment of the invention.

FIG. 2 illustrates an apparatus for manufacturing the cushion mat.

FIG. 3 is a diagram illustrating the manufacturing process when using the apparatus for manufacturing a cushion mat.

FIG. 4 and FIG. 5 each illustrate a feature portion of the apparatus for manufacturing a cushion mat during operation.

### DETAILED DESCRIPTION OF THE INVENTION

The objectives, characteristics, and advantages of the present invention mentioned above will become more clearly understood from the detailed descriptions provided below. Certain embodiments of the invention are described below with reference to the accompanying drawings.

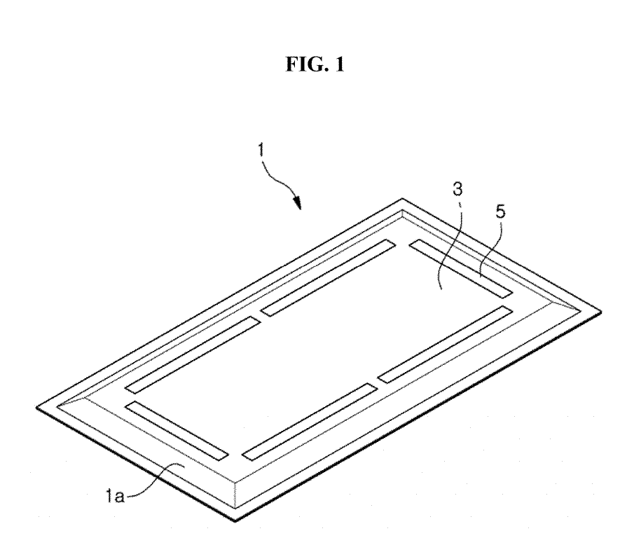

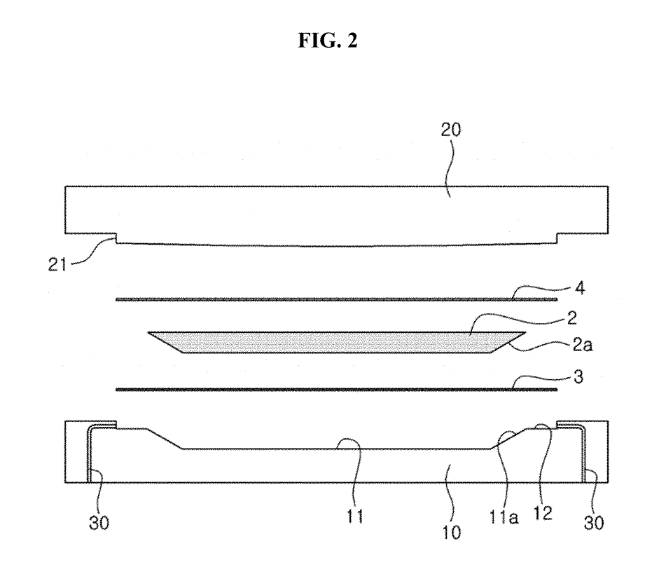

FIG. 1 through FIG. 5 illustrate an apparatus for manufacturing a cushion mat according to an embodiment of the invention as well as a cushion mat manufactured using this apparatus. As shown in the drawings, a cushion mat 1 based on an embodiment of the invention may include an inner filler 2 that is made of a synthetic resin expanded foam member, and a first sheet 3 and a second sheet 4 that cover the upper surface and lower surface of this inner filler 2, respectively, and may be manufactured by an apparatus that includes a lower mold 10, an upper mold 20, and air suction nozzles 30.

The lower mold 10 can have a concave part 12 formed in its upper side, the concave part 12 having a downwardly concave form, with a downwardly concave cavity 11 formed in a center portion of the concave part 12. Here, the side wall of the cavity 11 may form an inclined surface 11a that slopes upward towards the outer end. The air suction nozzles 30 may be installed in the side wall of the concave part 12.

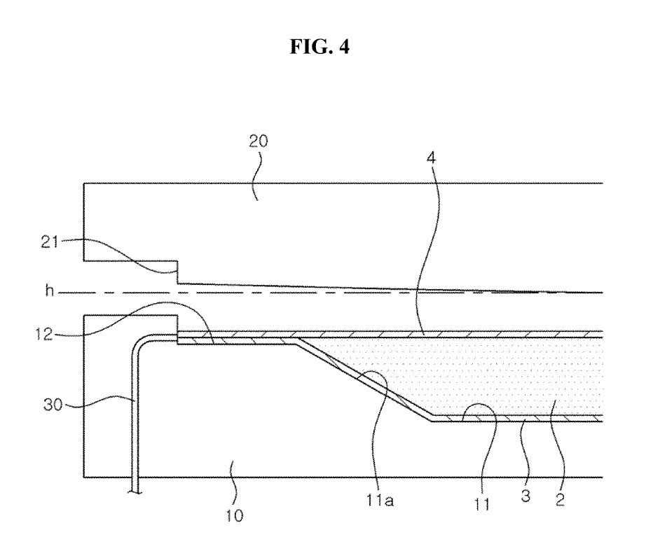

The upper mold 20 may be formed to mate with the lower mold 10, and in a lower side of the upper mold 20, a protrusion part 21 may be formed that is configured to be inserted into the concave part 12 of the lower mold 10. Here, the protrusion part 21 of the upper mold 20 may be formed to curve upward from the center towards the boundary, as can be seen in comparison with the horizontal line h depicted in FIG. 4.

The air suction nozzles 30 may remove any air remaining between the inner filler 2 and the second sheet 4 placed over the inner filler 2 by way of vacuum suction. Preferably, the air suction nozzles 30 may be installed in the lower mold 10, and in the illustrated embodiment, are installed with their front ends exposed at the inner wall of the concave part 12 in the lower mold 10.

While the illustrated example shows the air suction nozzles 30 embedded into the lower mold 10, the present invention is not limited thus. For example, if the lower mold 10 does not have a concave part 12 formed therein, the air suction nozzles 30 can be disposed over the lower mold 10, in which case slots for holding the air suction nozzles 30 can be formed in the upper mold 20. In some cases, the arrangement can involve the air suction nozzles 30 being removed by an operator or moved in connection with a separate sensor when the center portion of the upper mold 20 contacts the first sheet 3.

A method of manufacturing the cushion mat 1 using such apparatus is as follows.

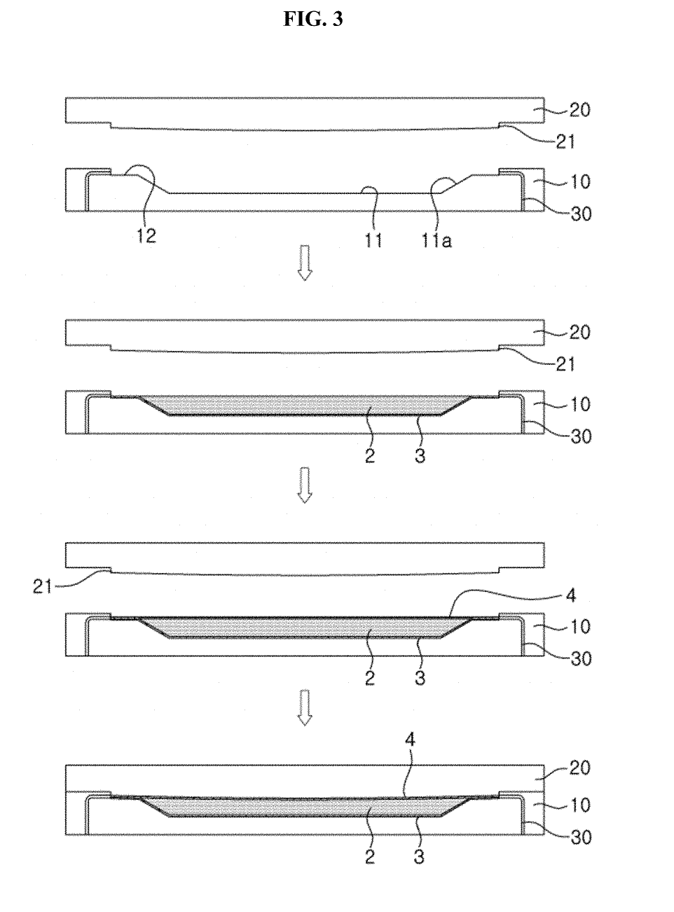

First, as shown in FIG. 3, the first sheet 3 may be inserted into the cavity 11 of the lower mold 10, with the boundary of the first sheet 3 positioned at the periphery part of the cavity 11, i.e. the concave part 12. Then, the inner filler 2 may be inserted in the cavity 11 of the lower mold 10 to be disposed on the upper surface of the first sheet 3, where the inner filler 2 may be molded with an inclined part 2a formed at the boundary, so that it may maintain tight contact with the inclined surface 11a of the cavity 11 of the lower mold 10. Here, residual air between the inner filler 2 and the first sheet 3 may be removed by vacuum suction via air suction nozzles (not shown), etc. Afterwards, the second sheet 4 may be disposed on the upper surface of the inner filler 2, with the boundary disposed overlapping the boundary of the first sheet 3.

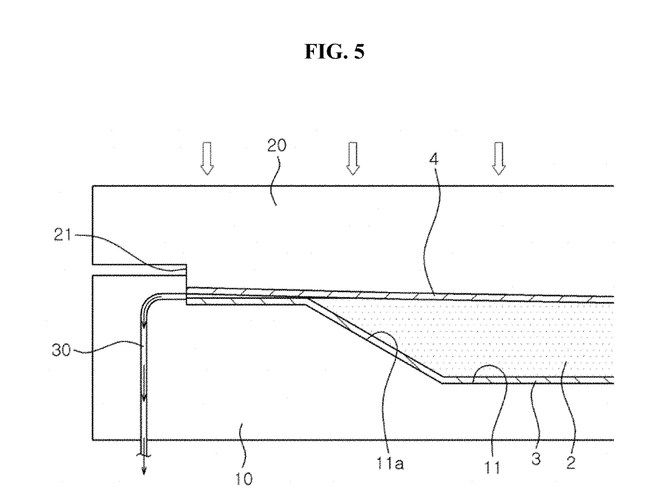

Then, the upper mold 20 may mate with the lower mold 10, during which the air remaining between the second sheet 4 and the inner filler 2 may be removed through air suction nozzles 30. Here, since the protrusion part 21 of the upper mold 20 may curve upwardly towards the boundary as shown in FIG. 4, the center portions of the second sheet 4 and the inner filler 2 may contact each other first, while the boundaries of the second sheet 4 and the inner filler 2 may be slightly separated, as shown in FIG. 5, so that the residual air between the second sheet 4 and the inner filler 2 may be removed by vacuum suction through the air suction nozzles 30. In this way, the upper mold 20 and the lower mold 10 may mate together to heat-seal the first and second sheets 3, 4 onto both sides of the inner filler 2. The boundaries of the attached first and second sheets 3, 4 may then be suitably trimmed.

A cushion mat 1 manufactured in this manner can include a phosphorescent coating layer 5 painted or laminated on the boundary of an upper surface of the first sheet 3, as shown in FIG. 1, to allow persons to perceive the cushion mat 1 even during nighttime. Such a phosphorescent coating layer 5 can be formed along the boundary of the first sheet 3. While the illustrated example shows the phosphorescent coating layer 5 in the form of intermittent multiple lines, the present invention is not limited thus. The phosphorescent coating layer 5 can be implemented in various forms, for example as a continuous line, dots, etc. By forming a phosphorescent coating layer 5 on an upper surface of the cushion mat 1 in this manner, persons may easily perceive the cushion mat 1 at night, so that accidents caused by bumping a foot into or tripping on the cushion mat 1 can be prevented. In particular, when considering use in a medical context, a physically weakened patient may be badly hurt if the patient trips on a cushion mat 1 at night, but with a cushion mat 1 based on an embodiment of the invention, this risk can be avoided.

Also, due to the inclined part 2a of the inner filler 2, the cushion mat 1 may have a downwardly inclined part 1a, which slopes downward from the upper surface, formed at the boundary. This not only provides improved safety, as accidents involving a person tripping on the cushion mat 1 can be avoided, but also provides improved convenience, since wheelchairs may easily move over the cushion mat 1 in a hospital.

It is to be appreciated that the present invention described above is not to be limited by the embodiments set forth above or by the accompanying drawings. It should be apparent to those of ordinary skill in the field of art to which the present invention pertains that various substitutions, alterations, and modifications can be derived without departing from the technical spirit of the present invention.

What is claimed is:

1. An apparatus for manufacturing a cushion mat, the cushion mat comprising an inner filler made of a synthetic resin expanded foam member, and a first sheet and a second sheet respectively covering an upper surface and a lower surface of the inner filler, the apparatus comprising:
a lower mold having a cavity formed in an upper surface thereof, the cavity configured to receive the first sheet and the inner filler sequentially, wherein the first sheet is disposed such that a boundary thereof is exposed at a periphery part of the cavity;
an upper mold configured to heat-seal the first sheet and the second sheet onto both sides of the inner filler by mating with the lower mold while the second sheet is disposed between the upper mold and the inner filler; and
a plurality of air suction nozzles disposed at the periphery part of the cavity of the lower mold, the air suction nozzles configured to remove residual air from between the second sheet and the inner filler by vacuum suction.

2. The apparatus for manufacturing a cushion mat according to claim 1, wherein the lower mold has a concave part formed in an upper side thereof, the upper mold has a protrusion part formed on a lower side thereof, the concave part formed by a recessing of the cavity and the periphery part of the cavity, the protrusion part configured to mate with the concave part of the lower mold,
and wherein the air suction nozzles are installed such that front ends of the air suction nozzles are exposed at an inner wall of the concave part of the lower mold.

3. A method of manufacturing a cushion mat, the cushion mat comprising an inner filler made of a synthetic resin expanded foam member, and a first sheet and a second sheet respectively covering an upper surface and a lower surface of the inner filler, the method comprising:
disposing the first sheet by inserting the first sheet in a cavity formed in a lower mold such that a boundary is exposed at a periphery part of the cavity;
inserting the inner filler into the cavity of the lower mold such that the inner filler is stacked over an upper surface of the first sheet;
disposing the second sheet over an upper surface of the inner filler such that a boundary overlaps the boundary of the first sheet; and
heat-sealing the first and second sheets onto both sides of the inner filler by way of an upper mold mating with the lower mold while removing residual air from between the inner filler and the second sheet by vacuum suction via an air suction nozzle.

4. A cushion mat manufactured by the apparatus of claim 1 such that no residual air remains between the first and second sheets and the inner filler.

5. A cushion mat manufactured by the apparatus of claim 2 such that no residual air remains between the first and second sheets and the inner filler.

6. A cushion mat manufactured by the method of claim 3 such that no residual air remains between the first and second sheets and the inner filler.
